(19) United States
(12) Patent Application Publication
(10) Pub. No.: US 2014/0170374 A1
(43) Pub. Date: Jun. 19, 2014

(54) Core of Sheet Structural Material and Assembly Process

(71) Applicant: Frederic Brun, Caen (FR)

(72) Inventor: Frederic Brun, Caen (FR)

(73) Assignees: Alexis Chermant, Auberville (FR); Frederic Brun, Caen (FR)

(21) Appl. No.: 14/138,793

(22) PCT Filed: May 23, 2012
(86) PCT No.: PCT/FR2012/051163

§ 371 Date: Feb. 27, 2014

(30) Foreign Application Priority Data
Jun. 23, 2011 (FR) 11 55567

(51) Int. Cl. B32B 3/12; B32B 3/28; B32B 3/26

(52) U.S. Cl. CPC B32B 3/12; B32B 3/266; B32B 3/28
USPC 428/116; 29/428

(57) ABSTRACT

A core of sandwich structural material comprising an assembly of several sheets comprising a first sheet and a second sheet that are provided on one of the faces thereof with of periodically distributed polygonal-based pyramid frustums, the superposition of these sheets in the thickness direction forming a three-dimensional network of hollow tubular channels which extend from one face of one sheet to one face of another sheet along a channel direction, and that are each defined by a peripheral wall, this peripheral wall being provided both by the first sheet and by the second sheet.

### FIELD OF THE INVENTION

The present invention relates to a core of structural material, a sheet as a core component, a sandwich structural material comprising such a core, as well as the method for producing such a core.

Sandwich structural materials are generally composed of two outer skins secured onto opposite sides of a core. Said core can be created from a wide variety of component materials and is made to have a high structural compressive strength and flexural strength while maintaining a minimal weight. These structural materials have many applications, for example in the aerospace and automotive industries.

Among these materials, the best known are those with a honeycomb core. These cores are made of sheets that are shaped and then fastened together at specific points to form a honeycomb of cells with hexagonal profiles, possibly deformed, which extend perpendicularly to said outer skins. Many materials can be used for constructing this core, for example cardboard, aluminum, plastic, composites, or metals.

As the sheets forming the core of the structural material are arranged orthogonally to the surface of the sandwich structure and their structure can be extended, the mechanical properties of honeycomb cores are highly anisotropic. They exhibit, for example, a lower flexural strength than compressive strength. Various structures have been developed to attempt to overcome this disadvantage.

### TECHNICAL BACKGROUND

Document FR-A-2 922476 describes an example of such a structure, formed of a stack of sheets equipped with a plurality of parallel ribs on their faces, said ribs being complementary between sheets. These sheets are stacked to form a non-extendable structure providing improved flexural and compressive rigidity.

### OBJECTS OF THE INVENTION

The present invention aims to provide a material and a core structure having improved strength characteristics while weighing less and offering an economically viable alternative to known solutions.

To this end, the core of sandwich structural material according to the invention is noteworthy in that:
it comprises at least a first sheet and a second sheet that are provided with a plurality of periodically distributed polygonal-based truncated pyramids (frustums),
superimposing said first and second sheets forms a three-dimensional network of hollow tubular channels that extend from one face of one sheet to one face of another sheet along a channel direction, and that are each defined by a peripheral wall, said peripheral wall being provided both by the first sheet and by the second sheet.

“Three-dimensional network of channels” is understood to mean that the network comprises at least three channels for which the channel directions are non-coplanar.

Each of said channels has a high compressive rigidity along its channel direction. As the network of tubular channels is three-dimensional, the mechanical strength of the structure is therefore significant in all spatial directions, which gives the material a significant flexural as well as compressive rigidity. The core of structural material according to the invention also has very good properties as an absorber of energy, for example impacts. Lastly, the channels or the spaces between channels allow the passage of cables and simplify the installation of sensors or gauges.

Advantageously, said first and second sheets are identical. The second sheet is turned over relative to the first sheet, on an axis lying within the plane of said sheet, in order to create said network of hollow channels when said sheets are placed atop one another. In this way, the cost and complexity of producing the cores can be significantly reduced.

Preferably, said truncated pyramids each comprise a base, sides, a top, and edges connecting the base to the top, said edges delimiting recessed areas between peripheral adhesion surfaces. The recessed areas of a first sheet are supplemented by the facing surfaces of a second sheet, defining the peripheral wall of the hollow tubular channels. These two sheets are secured together at the peripheral adhesion surfaces by an adhesion process, which for example may be welding, thermal bonding, or joining.

In order to obtain the best mechanical properties, the network of tubular channels will be three-dimensional, meaning it will comprise channels extending in non-parallel channel directions.

According to one embodiment of the invention, the first and second sheets may be superimposed in a staggered manner, the second sheet then being placed so it straddles multiple first sheets arranged side by side. This will ensure a good mechanical connection between said first sheets.

To extend the structural material in the thickness direction, the core of the present invention is advantageously such that:
it further comprises third and fourth sheets having the same characteristics as the first and second sheets and which when superimposed in the thickness direction form a three-dimensional network of hollow tubular channels,
said first and fourth sheets are superimposed and secured to each other by the tops of each of said truncated pyramids of said first and fourth sheets.

To ensure continuity of the hollow channels when several such sheet assemblies are superimposed, the tops of said truncated pyramids of said first and fourth sheets advantageously present a flat surface.

According to another embodiment of the present invention, the tops of the truncated pyramids of said first and fourth sheets have angled portions to ensure the alignment of the channel directions of said hollow channels when multiple sheet assemblies are superimposed. This alignment will give the strongest mechanical properties to the structure.

The invention also relates to a sheet having a plurality of periodically distributed polygonal-based truncated pyramids. Such pyramids have recessed areas between peripheral adhesion surfaces, such recessed areas of two superimposed sheets then defining hollow tubular channels.

A core according to the present invention can easily be provided with at least one outer skin attached to at least one of its opposite faces to form a sandwich structural material.

Finally, the invention also relates to a method for producing a core of sandwich structural material comprising an assembly of multiple sheets including at least a first sheet and a second sheet that are provided on at least one of the faces thereof with a plurality of periodically distributed polygonal-based truncated pyramids, said pyramids having recessed areas between the peripheral adhesion surfaces, the recessed areas of said superimposed sheets defining hollow tubular channels, said method characterized by its comprising at least the following steps:
a step of forming said truncated pyramids in said sheets, and
a step of superimposing said sheets and attaching them to one another.

According to a first embodiment of this production method, the step of forming the truncated pyramids in said sheets includes a step of folding said sheets.

According to a second embodiment of this production method, the step of forming the truncated pyramids in said sheets includes a step of plastic deformation of the sheets.

According to a variant of these embodiments, a plurality of openings are created beforehand in the sheets to reduce the amount of structural material in the core.

It is also possible to shape and assemble a third sheet and a fourth sheet in a manner identical to said first and second sheets, then to stack and attach said first and fourth sheets to one another by the tops of their truncated pyramids.

In general, some embodiments of the invention provide the following advantages. The production method is easily applied on an industrial scale because the steps are simple to implement using existing technical means. The sheets can all be identical and the formation of the network of hollow tubes and then of the structural material is done simply by turning the sheets over before they are superimposed and assembled. The core of sandwich structural material can be of arbitrary thickness and dimensions. As the mechanical strength of the material, whether flexural or compressive, depends only on the hollow tubular network, the core of the sandwich structural material can be significantly lightened by creating openings in the sheets that constitute the structure. Finally, as the tubular network is three-dimensional, the mechanical strength of the material is much higher, at equal volume, than that of honeycomb-type materials.

### BRIEF DESCRIPTION OF THE DRAWINGS

Other features and advantages of the invention will become apparent from the following description.

In the drawings:

FIG. 1 is perspective view of a sheet of the assembly constituting the core of sandwich structural material,

FIG. 2a shows a unit cell of said sheet,

FIG. 2b and FIG. 2c show how two unit cells of two sheets are superimposed to create the network of hollow channels,

FIGS. 2d and 2e correspond to cross-sections along IID and IIE and illustrate the position of the hollow tubular channels created by superimposing the first and second sheets,

FIG. 3 shows an embodiment in which openings are created in the sheets, leaving only the hollow channels and peripheral adhesion surfaces,

FIG. 4 shows the assembly of two sandwiches, each constructed by superimposing a first and a second sheet,

FIGS. 5a, 5b and 5c detail the structures located at the tops of the truncated pyramids, which allow stacking the sandwiches of FIG. 4,

FIG. 6 shows a staggered assembly of multiple sheets to form a structure extending over a large area.

FIGS. 7a, 7b and 7c show other embodiments according to the present invention, in which the bases of the truncated pyramids, and the network formed by these pyramids, are different,

FIGS. 8a, 8b and 8c, as well as FIGS. 9a and 9b, show two methods for producing a sheet of the invention by folding a previously embossed sheet,

FIG. 10 shows a manufacturing process of the present invention according to one embodiment.

In the various figures, the same references designate identical or similar elements.

### DETAILED DESCRIPTION

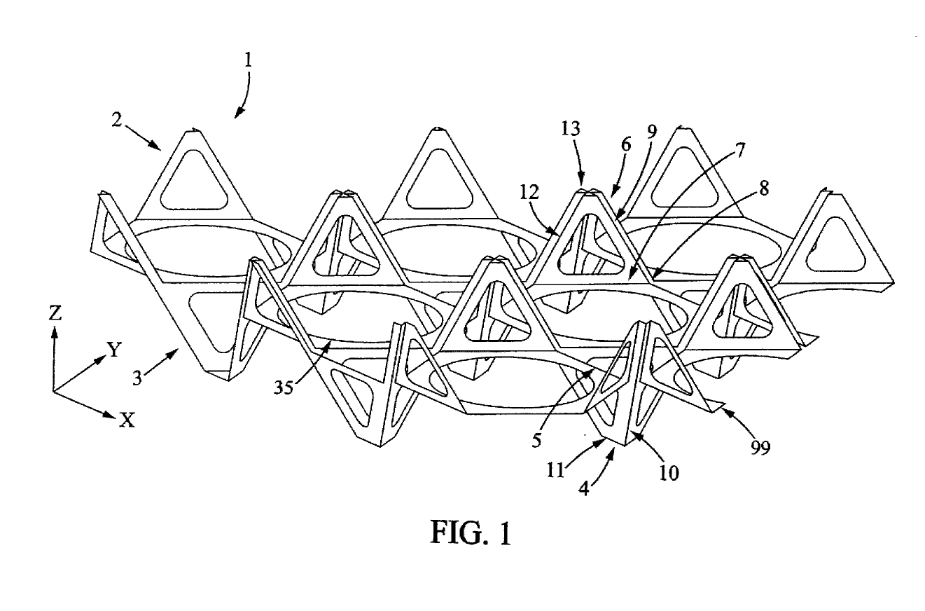

FIG. 1 shows a sheet 1 from an assembly constituting the core of sandwich structural material according to an embodiment of the present invention. This sheet 1 extends in extension directions X and Y and has an upper face 2 and a lower face 3 located on either side of a central plane 99, said faces therefore facing away from each other along the thickness direction Z.

On the lower face 3, the sheet has a periodic network of truncated pyramids 4 each shaped to have a top 11, edges 10, and a triangular base 5 on the central plane 99. On the upper face 2, the sheet has a periodic network of truncated pyramids 6 each consisting of a base 7, edges 12, and a top 13. The bases 7 are located on the central plane 99. They are generally triangular with recessed sides 8 at the tops. These recessed sides 8 extend along the edges 12 to form recessed areas 9 running from the base 7 to the top 13 of the truncated pyramids 6.

The network formed by said bases 5 and said bases 7 on the central plane 99 is a Kagome lattice, meaning that the bases 5 are each surrounded by three bases 7 which are each connected to their respective base 5 by a pyramid top. The tops of said bases 5 slightly penetrate the tops of said bases 7, which creates said recessed sides 8 at said tops of said bases 7. Flat hexagons 35 complete the central plane, each of their sides corresponding to a separate truncated pyramid. As shown in FIG. 1, the quadrilateral faces of the truncated pyramids and the hexagons 35 can be cut out to lighten the structure.

Other networks and other shapes for the polygonal bases 5 and 7 of said truncated pyramid 4 and 6 can be considered, as indicated below. The central plane 99 may be omitted in some embodiments.

The sheet 1 may be made for example of a material such as a plastic, metal, alloy, composite, or resin. The thickness of the component material of the sheet 1 can range from 5 micrometers to 2 millimeters.

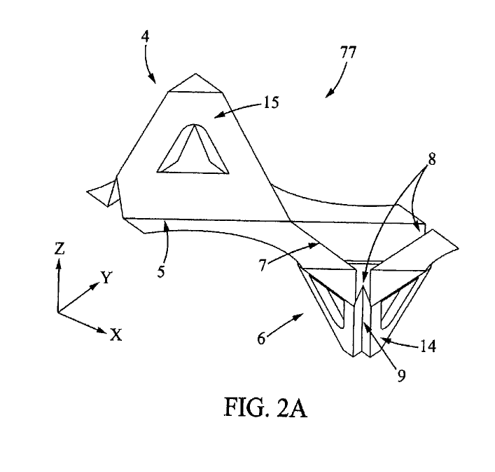

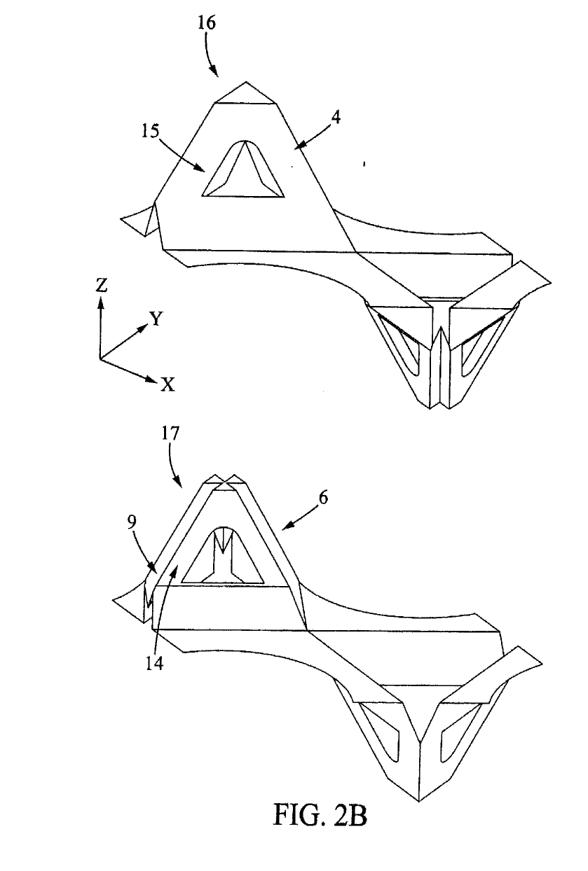

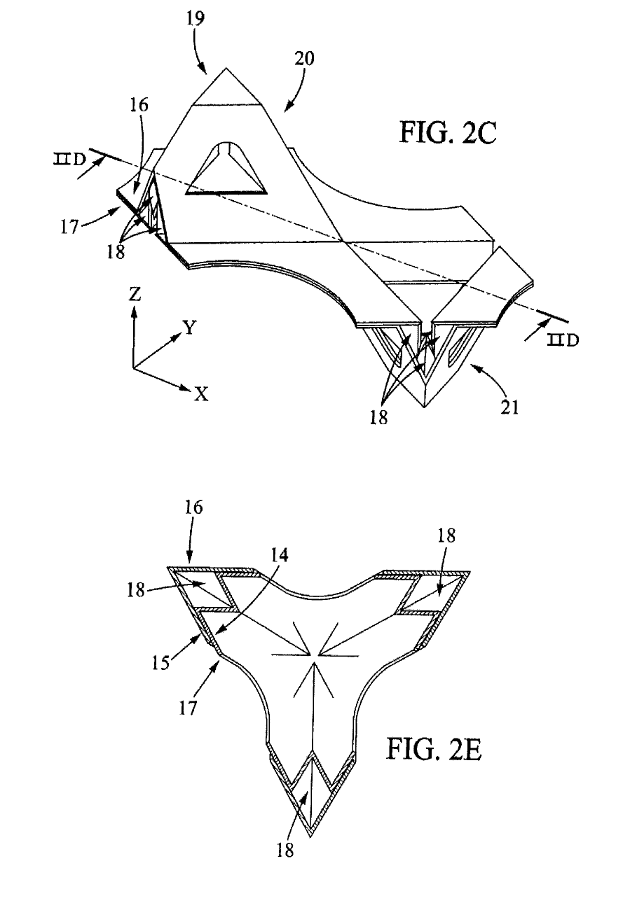

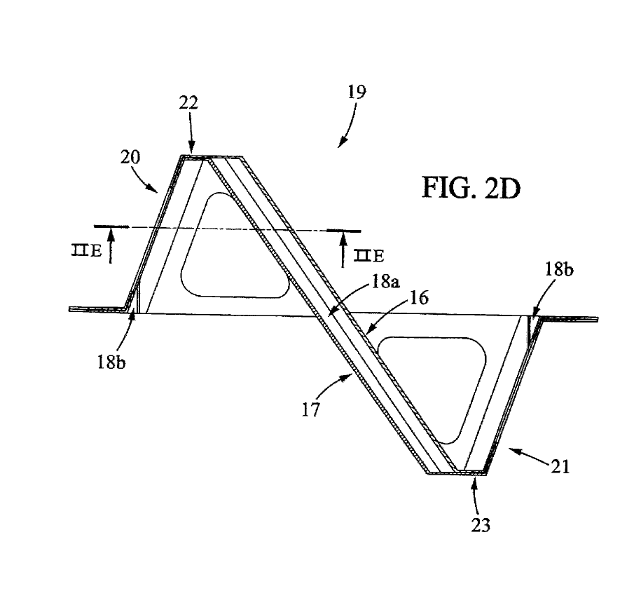

FIGS. 2a to 2e illustrate the assembly of two sheets in a variant of the embodiment of FIG. 1, in order to form a network of hollow tubular channels.

In FIG. 2a, a unit cell 77 has been isolated from a variant embodiment of the sheet 1. This unit cell consists of a truncated pyramid 4 and a truncated pyramid 6. The recessed areas 9 form halves of the hollow tubular channels and are surrounded by peripheral adhesion surfaces 14.

FIG. 2b shows how two sheets 16 and 17, identical to the sheet 1 of FIG. 1, must be positioned relative to each other before being stacked in order to create said network of hollow channels. Sheet 16 is flipped over relative to sheet 17, on an axis of rotation located within the plane of said sheet 16, which is the plane (X, Y). This operation places the truncated pyramids 6 of sheet 17 so they are facing the truncated pyramids 4 of sheet 16, and places the peripheral adhesion surfaces 14 so they are facing the parallel peripheral adhesion surfaces 15.

Sheets 16 and 17 are then brought into contact with one another and fastened together at surfaces 14 and 15 in order to obtain the sandwich 19 of FIG. 2c. Superimposing the truncated pyramids 6 of sheet 17 and the truncated pyramids 4 of sheet 16 completes the recessed areas 9 of truncated pyramid 6 with the walls of the truncated pyramid 4, obtaining hollow tubular channels 18 having walls formed by both sheet 16 and sheet 17. The sandwich 19 of FIG. 2c thus comprises truncated pyramids 20 on the upper face and truncated pyramids 21 on the lower face, said pyramids 20 and 21 being symmetrical to each other relative to plane (X, Y), formed by the assembly of the two sheets 16 and 17, and each comprising hollow tubular channels 18.

Sectional view 2d of the sandwich 19, along the plane (X, Z), provides a view of a hollow tubular channel 18a sliced off at a plane containing its channel direction, said hollow channel therefore being visible along its largest dimension, as well as two hollow tubular channels 18b whose channel directions run in the Y direction and are therefore sliced transversely to said channel direction. The walls of channels 18a and 18b are formed in part by sheet 16 and in part by sheet 17. Channel 18a extends from the top 22 of pyramid 20 to the top 23 of pyramid 21. Its channel direction thus includes non-zero components in the X and Z directions. The directions of the channels 18b include non-zero components in the Y direction. Other hollow tubular channels 18 of the sandwich 19 possess channel directions extending in other spatial directions.

Sectional view IIE of the sandwich 19, along plane (X, Y) through the truncated pyramid 20, provides a view of three hollow tubular channels 18 located at the tops of base 7 of said truncated pyramid 20. Sectional view IIE also shows how the peripheral surfaces 14 and 15 are superimposed in order to attach sheets 16 and 17 together.

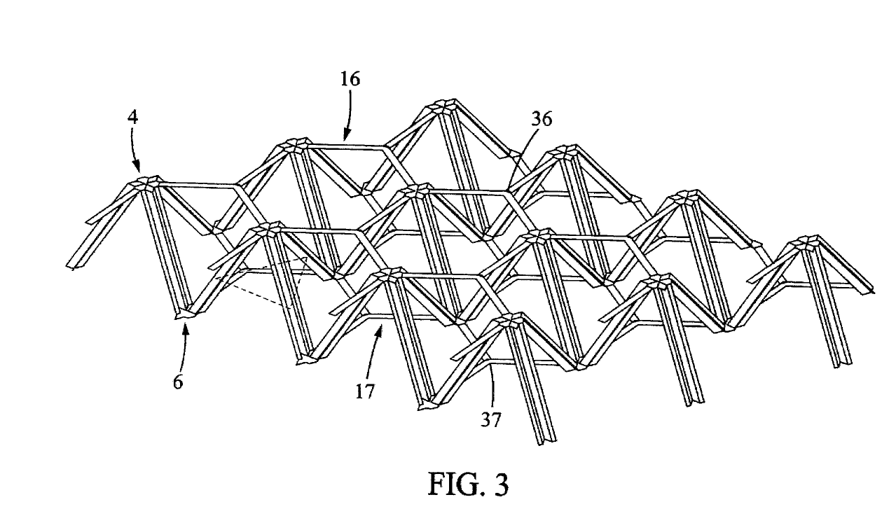

FIG. 3 shows a sandwich 19 according to another embodiment of the invention. The network of hollow channels is three-dimensional and the channels extend in all spatial directions, which gives advantageous mechanical properties to the structure. In the embodiment shown in FIG. 3, openings have been made in the sheets 16 and 17, leaving only the walls of the hollow tubular channels and the peripheral adhesion surfaces, in order to lighten the structure. Thus, this embodiment does not provide a central plane; the base of a pyramid is represented with dotted lines. In addition, adjacent pyramid tops are interconnected, for example in threes, by a radial structure 36, 37.

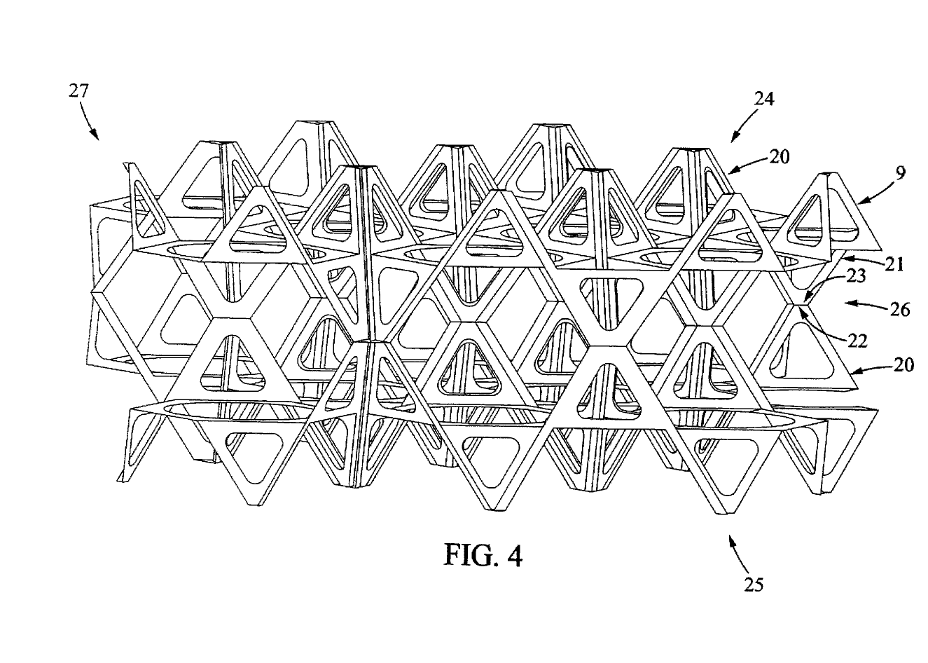

According to one embodiment of the present invention shown in FIG. 4, two sandwiches 24 and 25, each consisting of two superimposed sheets 16 and 17 as detailed in FIG. 2c for sandwich 19, can be stacked to extend the core 27 in thickness. Sandwiches 24 and 25 are interconnected by assembling 26 the tops 23 of the truncated pyramids 21 of sandwich 24 and the tops 22 of the truncated pyramids 20 of sandwich 25.

According to other embodiments of the present invention, other sandwiched sheets 19 may be superimposed onto said core 27, thus allowing the formation of a core of arbitrary thickness.

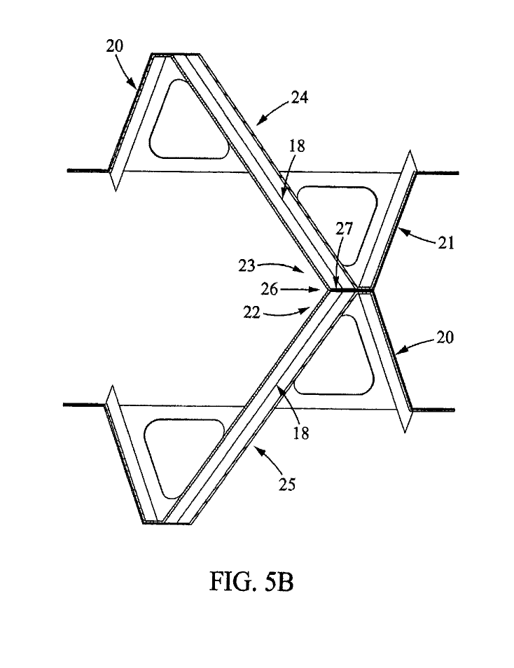

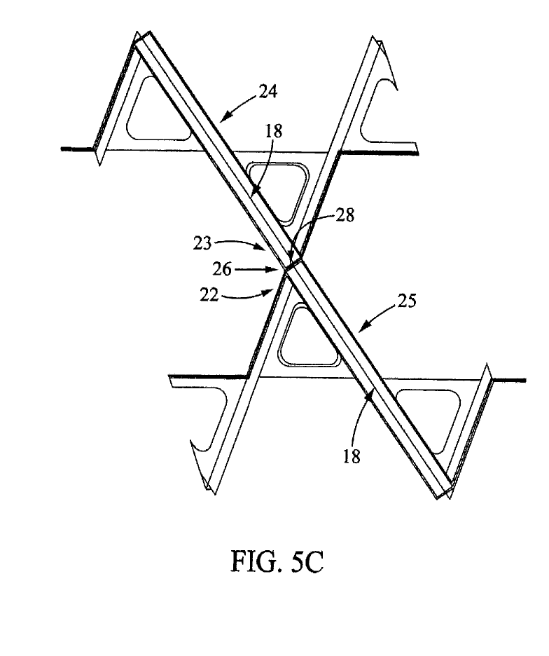

FIGS. 5a, 5b and 5c show two embodiments of the assembly 26 of said tops 22 and 23 of sandwiches 24 and 25. FIG. 5a is a top view of the core 27 of FIG. 4, showing the plane for sectional views 5B and 5C.

In a first embodiment of tops 22 and 23, shown in FIG. 5b, said tops are formed by flat surfaces 27. The assembly 26 of said flat surfaces 27 places the ends of the hollow tubular channels 18 of sandwiches 24 and 25 so they are facing one another.

In a second embodiment, shown in FIG. 5c, the tops 22 and 23 have angled portions 28 which allow aligning the channel directions of the channels 18 of sandwich 24 and sandwich 25. The plane of sectional view 5C of said recessed portions 28 is orthogonal to the channel direction of the channels 18. This embodiment provides better transfer of the forces exerted on the tubular channels 18 from one sandwich to another.

Other embodiments of said assembly 26 can be used by a person skilled in the art by varying the geometry of the tops 22 and 23.

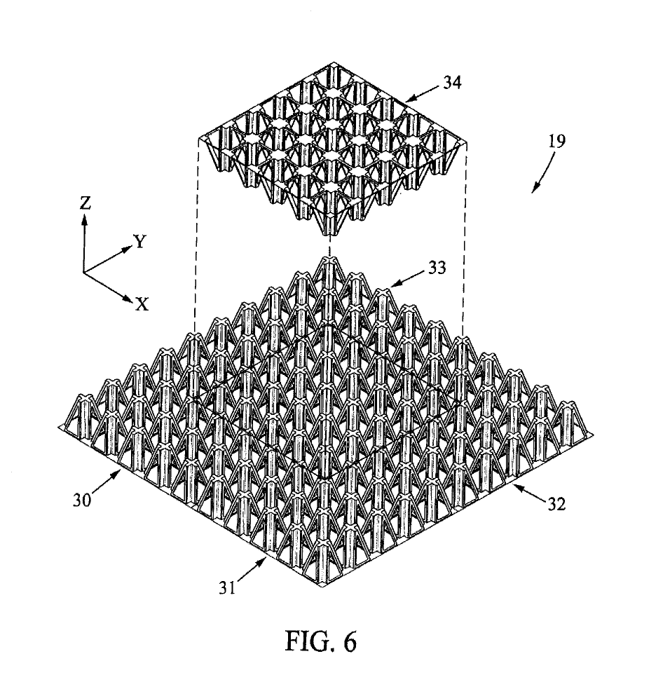

Finally, as shown in FIG. 6, a sandwich 19 of two sheets can be formed in a staggered manner to further extend a core of sandwich structural material. In one embodiment, to achieve this, sheet 34 is superimposed and secured such that it straddles four sheets 30, 31, 32 and 33, forming a strong structure. Such an assembly significantly improves the mechanical properties when assembling multiple sheets in the extension plane (X, Y), in comparison to a simple bonding of the ends of said sheets or a simple extendable stacking.

In other embodiments of the invention, the recessed sides 8 can be placed in other areas of the base 7, for example on the sides of said base, and in all embodiments can be replaced by or associated with protruding sides, extending via the edges 12 as protruding areas, on the truncated pyramids 4 or 7.

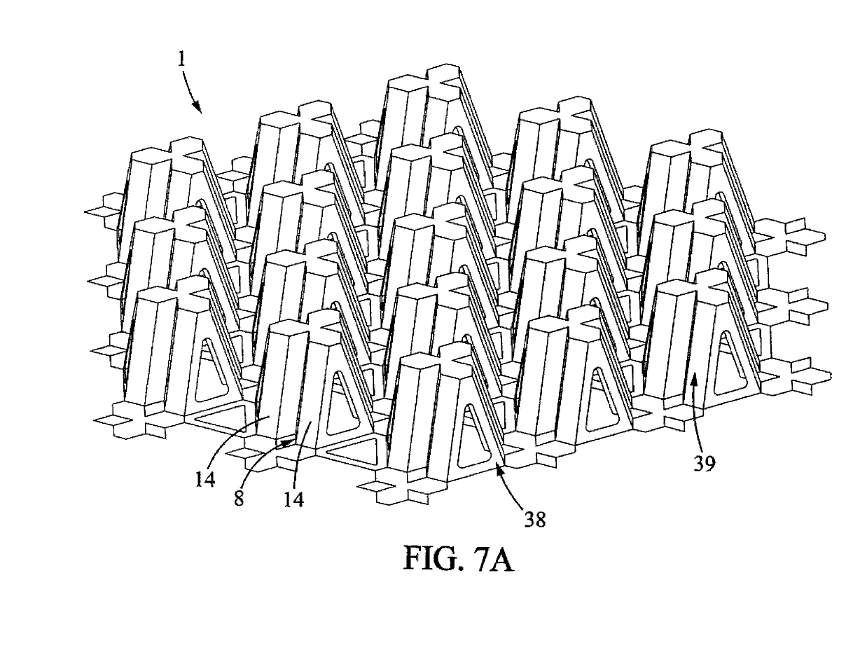

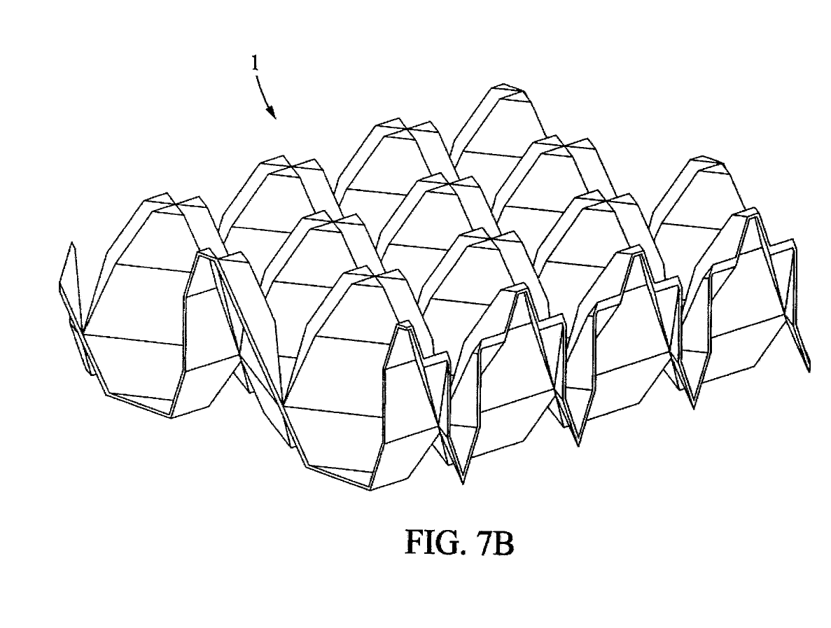

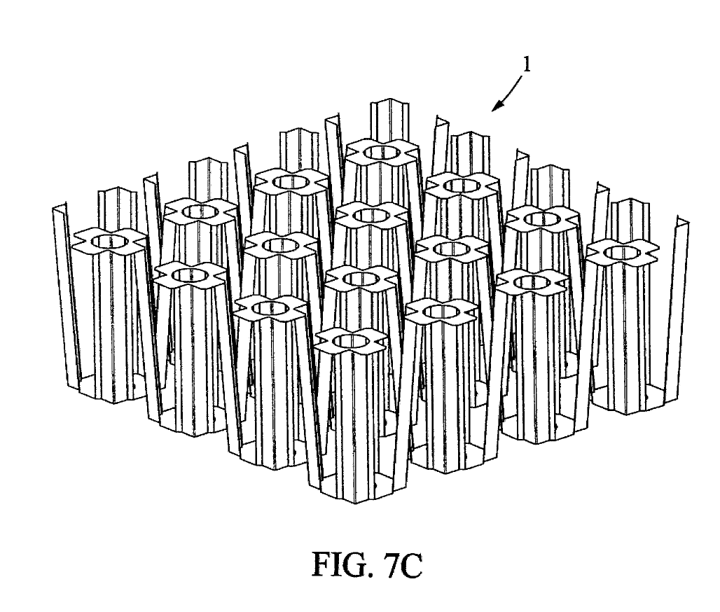

FIG. 7a shows another embodiment of the sheet 1 from the assembly constituting the core of sandwich structural material. In this embodiment, the truncated pyramids have a hexagonal base and hollowed triangular faces 38 alternating with quadrilateral faces 39. The recessed areas 8 are formed in the quadrilateral faces 39 of the truncated pyramids. The area surrounding the recessed area forms the peripheral adhesion surface 14. The central plane 99 is absent in this embodiment.

FIG. 7b shows another embodiment of said sheet 1 in which the truncated pyramids are assembled in a triangular lattice, the triangular bases of said pyramids being joined at their sides.

FIG. 7c shows yet another embodiment of the sheet of FIG. 1, in which the truncated pyramids have a square base, with recessed areas at the edges of said squares.

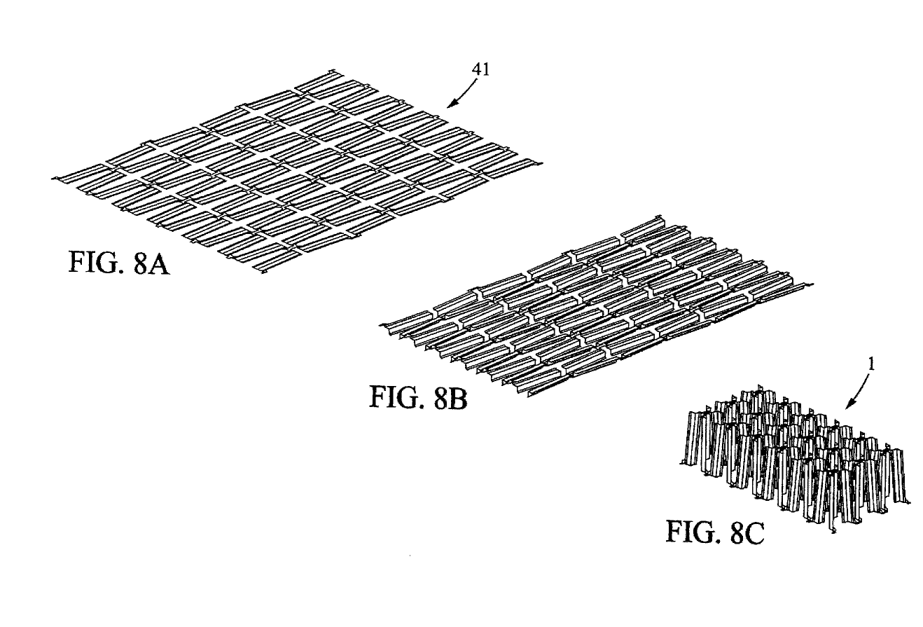

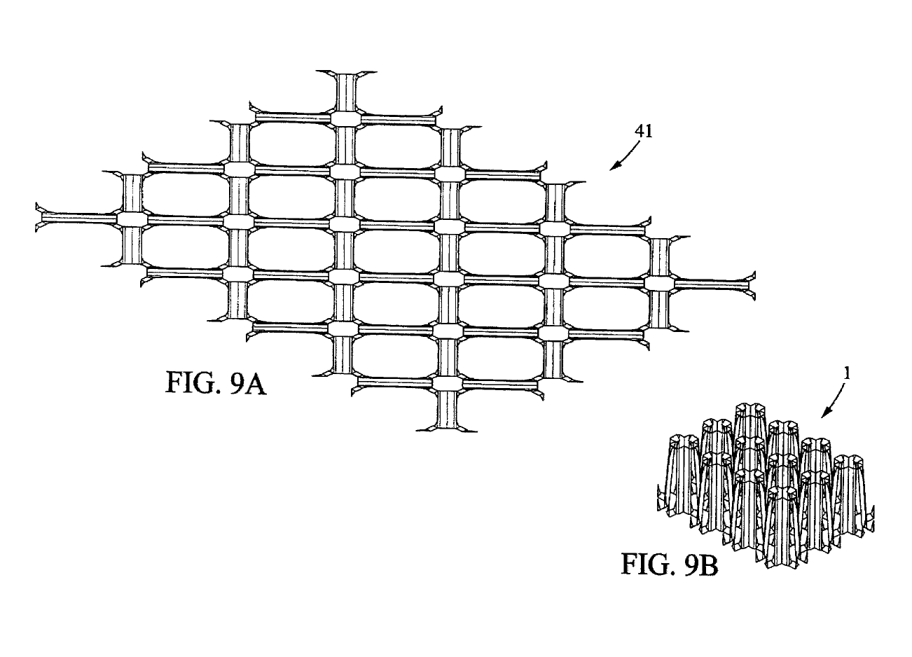

A method for producing a sheet according to the invention is shown in FIGS. 8a, 8b and 8c. Starting with a sheet 41 in which openings have been created, two folding steps shown in FIGS. 8a and 8b result in the sheet 1 shown in FIG. 8c.

Another method for producing a sheet of the invention is shown in FIGS. 9a and 9b, starting with a sheet 41 having previously created openings as shown in FIG. 9a. A single folding step results in the sheet 1 of FIG. 9b.

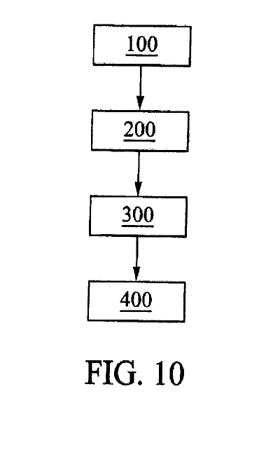

Finally, a method for producing a core of sandwich structural material according to an embodiment of the invention is shown in FIG. 10, wherein an optional first step 100 consists of creating holes in a sheet to reduce the material and where necessary to allow easier folding of said sheet. In step 200, the truncated pyramids are formed in said sheet by folding the sheet, plastic deformation, embossing, injection molding the sheet, and/or any other method or combination of the above methods for creating such a sheet providing truncated pyramids. A step 300 then consists of superimposing and attaching pairs of sheets providing truncated pyramids in order to obtain the network of hollow tubular channels. Finally, during step 400, the sandwiches obtained in step 300 are stacked and attached to one another to form a core of arbitrary dimensions.

A sandwich structural material can be obtained by superimposing, on at least one of the opposite faces of a core obtained by one of the embodiments of the production method described above, an outer skin or two outer skins. Said skins are for example formed of a composite material of fiber reinforced plastic.

1. A core of sandwich structural material comprising an assembly of multiple sheets including a first sheet extending substantially in extension directions and having first and second faces facing away from each other along a thickness direction, at least one face of this sheet being provided with a plurality of periodically distributed polygonal-based truncated pyramids, characterized in that it comprises at least one second sheet having the same characteristics as said first sheet and
in that superimposing said first and second sheets in the thickness direction forms a three-dimensional network of hollow tubular channels that extend from one face of one sheet to one face of another sheet along a channel direction, and that are each defined by a peripheral wall, said peripheral wall being provided both by the first sheet and by the second sheet.

2. The core according to claim 1, wherein said first and second sheets are identical, the second sheet being turned over relative to the first sheet, on an axis lying within the extension plane, in order to create said network of hollow channels when said sheets are placed atop one another.

3. The core according to claim 1, wherein said truncated pyramids each comprise a base, a top, and edges connecting the base to the top, said edges delimiting recessed areas between peripheral adhesion surfaces, the recessed areas of a first sheet being completed by the facing surfaces of a second sheet and thus forming hollow tubular channels.

4. The core according to claim 1, wherein the network of hollow tubular channels comprises at least three channels for which the channel directions are non-coplanar.

5. The core according to claim 1, wherein the first and second sheets are superimposed in a staggered manner, the second sheet being placed so it straddles the first sheet and other sheets in the assembly of multiple sheets.

6. The core according to claim 1, wherein said core comprises a third sheet and a fourth sheet both extending in the extension directions and each having first and second faces facing away from each other along a thickness direction, each sheet being provided on at least one of its faces with a plurality of periodically distributed polygonal-base truncated pyramids,
wherein the superimposition of said third and fourth sheets in the thickness direction forms a three-dimensional network of hollow tubular channels extending from one face of one sheet to one face of another sheet in a channel direction, each channel defined by a peripheral wall, said peripheral wall being provided by both the third and fourth sheets,
wherein said first and fourth sheets are superimposed and secured to each other by assembling the tops of each of said truncated pyramids of said first and fourth sheets.

7. The core according to claim 6, wherein the tops of said truncated pyramids of said first and fourth sheets present a flat surface to ensure the continuity of the hollow tubular channels when multiple sheet assemblies are stacked.

8. The core according to claim 6, wherein the tops of the truncated pyramids of said first and fourth sheets have angled portions to ensure the alignment of the channel directions of the hollow tubular channels when multiple sheet assemblies are superimposed.

9. A sheet providing on at least one of its faces a plurality of periodically distributed polygonal-based truncated pyramids, said truncated pyramids having recessed areas between the peripheral adhesion surfaces, it being possible to supplement the recessed areas of such a sheet with the surfaces of a superimposed sheet in order to define hollow tubular channels.

10. A sandwich structural material comprising a core consisting of a structure according to claim 1 and at least one outer skin attached to at least one of the opposite faces of said structure.

11. A method for producing a core of sandwich structural material comprising an assembly of multiple sheets including at least a first sheet and a second sheet that are provided on at least one of the faces thereof with a plurality of periodically distributed polygonal-based truncated pyramids, said pyramids having recessed areas between the peripheral adhesion surfaces, the recessed areas of said superimposed sheets defining hollow tubular channels, said method characterized by its comprising at least the following steps:
a step of forming said truncated pyramids in said sheets, and a step of superimposing said sheets and attaching them to one another.

12. The method according to claim 11, wherein the step of forming said truncated pyramids in said sheets includes a step of folding said sheets.

13. The method according to claim 11, wherein the step of forming said truncated pyramids in said sheets includes a step of plastic deformation of said sheets.

14. The method according to claim 11, wherein it further comprises a step of creating a plurality of openings in said sheets prior to their shaping so as to reduce the amount of structural material in the core.

15. The method according to claim 11, wherein a third sheet and a fourth sheet are shaped and assembled in a manner identical to said first and second sheets, and during a subsequent step said first and fourth sheets are stacked and attached to one another by the tops of their truncated pyramids.
